(19) United States
(12) Patent Application Publication
(10) Pub. No.: US 2013/0080046 A1
(43) Pub. Date: Mar. 28, 2013

(54) APPARATUS AND METHOD FOR GUIDING DRIVING ROUTE TO DESTINATION

(71) Applicants: Seong Kyun JEONG, Gyeonggi-do (KR); Sang Uk LEE, Daejeon (KR)

(72) Inventors: Seong Kyun JEONG, Gyeonggi-do (KR); Sang Uk LEE, Daejeon (KR)

(73) Assignee: Electronics and Telecommunications Research Institute, Daejeon (KR)

(21) Appl. No.: 13/425,554

(22) Filed: Mar. 21, 2012

(30) Foreign Application Priority Data
Sep. 26, 2011 (KR) 10-2011-0097040

(51) Int. Cl. G01C 21/34

(52) U.S. Cl. 701/408; 701/538

(57) ABSTRACT

Disclosed are an apparatus and a method for guiding a driving route to a destination that accept a user's needs for a driving route as much as possible and promptly reflect traffic information in real time to guide a driver to arrive at his or her destination by using an optimal route.

### CROSS-REFERENCE TO RELATED APPLICATIONS

This application claims priority to and the benefit of Korean Patent Application No. 10-2011-0097040 filed in the Korean Intellectual Property Office on Sep. 26, 2011, the entire contents of which are incorporated herein by reference.

### TECHNICAL FIELD

The present invention relates to an apparatus and a method for guiding a driving route to a destination. More particularly, the present invention relates to an apparatus and a method for guiding a driving route to a destination for a vehicle.

### BACKGROUND ART

A global positioning system (GPS) for a vehicle is a device that receives a satellite navigation signal, calculates a location of a vehicle, and guides a route from a starting point to a destination to a user to enable the user to easily find the destination.

The GPS for a vehicle in the related art enables a user to search a route from a starting point to a destination by setting options such as a toll road, a free road, and the shortest distance. However, the GPS has a problem in that traffic conditions and road conditions of a selected route are not reflected and thus a driving time becomes longer compared to a detour route.

In order to solve the problem, a method of providing a driving route and traffic information together in the related art has been suggested. However, since the method simply displays the searched driving route and traffic information on the GPS for a vehicle, there is difficulty in selecting an optimal route suitable for traffic conditions during actual driving and further it is difficult for a user to select a specific route and reflect a desired traveling route.

Further, a method of previously storing an alternative route and guiding the alternative route instead of an existing route depending on traffic conditions has been suggested. However, the method has a disadvantage in that a user's intention such as allowing a user to select a familiar road is not reflected.

### SUMMARY OF THE INVENTION

The present invention has been made in an effort to provide an apparatus and a method for guiding a driving route to a destination that accept a user's needs for a driving route as much as possible and promptly reflect traffic information in real time to guide a driver to arrive at his or her destination by using an optimal route.

An exemplary embodiment of the present invention provides an apparatus for guiding a driving route to a destination, including: a driving route search unit searching driving routes from a current point to a destination point when the destination point is input; a selected route guidance unit guiding a selected route selected from the driving routes; a traffic condition collection unit collecting traffic condition information for each section from an appointed point to the destination point when approaching the appointed point while executing the guidance; and an optimal route detector detecting an optimal route from the appointed point to the destination point based on the traffic condition information.

The optimal route detector may detect a driving route to enable driving in the shortest time as the optimal route.

Whenever approaching the appointed point prior to the arrival at the destination point, the traffic condition collection unit and the optimal route detector may be repeatedly driven.

The driving route search unit may search passing routes passing through at least one appointed point as the driving routes or the optimal route detector may detect passing routes passing through at least one appointed point selected from the other appointed points except for an approached appointed point, as the optimal route.

The apparatus for guiding a driving route may further include a driving route selection unit selecting any one of a route corresponding to a user's input, a route to enable driving in the shortest time, a route to enable driving the shortest distance, and a route having fewest traffic signal waiting sections, as the selected route. The driving route selection unit may select any one route according to a predetermined order of priority when there are at least two selectable routes.

The apparatus for guiding a driving route may further include a current location calculation unit calculating a current location in real time; and an appointed point approach determination unit determining whether to approach the appointed point based on a time required to drive from the current location to the appointed point or a distance from the current location to the appointed point.

The apparatus for guiding a driving route may further include a route monitoring unit performing simulated driving of the other routes except for the optimal route to monitor the other routes in real time.

Another exemplary embodiment of the present invention provides a method for guiding a driving route to a destination, including: searching driving routes from a current point to a destination point when the destination point is input: guiding a selected route selected from the driving routes; collecting traffic condition information for each section from an appointed point to the destination point when approaching the appointed point while executing the guidance; and detecting an optimal route from the appointed point to the destination point based on the traffic condition information.

The detecting of the optimal route may detect a driving route to enable driving in the shortest time as the optimal route.

Whenever approaching the appointed point prior to the arrival at the destination point, the collecting of the traffic condition information and the detecting of the optimal route may be repeatedly performed.

The searching of the driving routes may search passing routes passing through at least one appointed point as the driving routes or the detecting of the optimal route may detect passing routes passing through at least one appointed point selected from the other appointed points except for an approached appointed point, as the optimal route.

The method for guiding a driving route to a destination may further include selecting any one of a route corresponding to a user's input, a route to enable driving in the shortest time, a route to enable driving the shortest distance, and a route having fewest traffic signal waiting sections, as the selected route, which is performed between the searching of the driving route and the guiding of the selected route. The selecting of the driving route may select any one route according to a predetermined order of priority when there are at least two selectable routes.

The method for guiding a driving route to a destination may further include: calculating a current location in real time; and determining whether to approach the appointed point based on a time required to drive from the current location to the appointed point or a distance from the current location to the appointed point, which is performed between the guiding of the selected route and the collecting of the traffic condition information.

The method for guiding a driving route to a destination may further include: performing simulated driving of the other routes except for the optimal route to monitor the other routes in real time, which is performed after the detecting of the optimal route.

According to exemplary embodiments of the present invention, it is possible to achieve the following effects by accepting a user's needs for a driving route as much as possible and promptly reflecting traffic information in real time to guide a driver to arrive at a destination by using an optimal route. First, user-customized route guidance reflecting a user's intention from multiple routes is made possible. Second, it is possible to guide an optimal route such as driving by a roundabout route to avoid an area where traffic conditions are not good by reflecting traffic information in real time. Namely, it is possible to guide an optimal route by generating various detour routes using the latest traffic information at every arrival at a route junction. Third, it is possible to achieve a great economic effect of reducing time and cost required for driving by generating the optimal route according to the present invention. Fourth, it is possible to achieve an economic effect by using the optimal route by displaying the time required by using simulated driving of routes where driving is not executed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically showing an apparatus for guiding a driving route according to an exemplary embodiment of the present invention.

FIGS. 2A, 2B and 2C is a block diagram schematically showing a configuration added to the apparatus for guiding a driving route shown in FIG. 1

FIG. 3 is an exemplary diagram showing an exemplary embodiment of the apparatus for guiding a driving route shown in FIG. 1

FIG. 4 is an exemplary diagram for describing a method for guiding an optimal route based on multiple routes by using the apparatus shown in FIG. 3.

FIG. 5 is a flowchart schematically showing a method for guiding a driving route according to an exemplary embodiment of the present invention.

FIG. 6 is a flowchart showing an exemplary embodiment of a method for guiding an optimal route by using the apparatus shown in FIG. 3.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, it should be noted that in giving reference numerals to elements of each drawing, like reference numerals refer to like elements even though like elements are shown in different drawings. Further, in describing the present invention, well-known constructions or functions will not be described in detail since they may unnecessarily obscure the understanding of the present invention. Hereinafter, the exemplary embodiment of the present invention will be described, but it will be understood to those skilled in the art that the spirit and scope of the present invention are not limited thereto and various modifications and changes can be made.

Disclosed are an apparatus and a method for guiding a driving route to a destination that accept a user's needs for a driving route as much as possible and promptly reflect traffic information in real time to guide a driver to arrive at his or her destination by using an optimal route. To this end, the present invention provides an apparatus including: a driving route search unit searching driving routes from a current point to a destination point when the destination point is input; a selected route guidance unit guiding a selected route selected from the driving routes; a traffic condition collection unit collecting traffic condition information for each section from an appointed point to the destination point when approaching the appointed point while executing the selected route guidance; and an optimal route detector detecting an optimal route from the appointed point to the destination point based on the traffic condition information. According to the present invention, it is possible to guide an optimized route for a user.

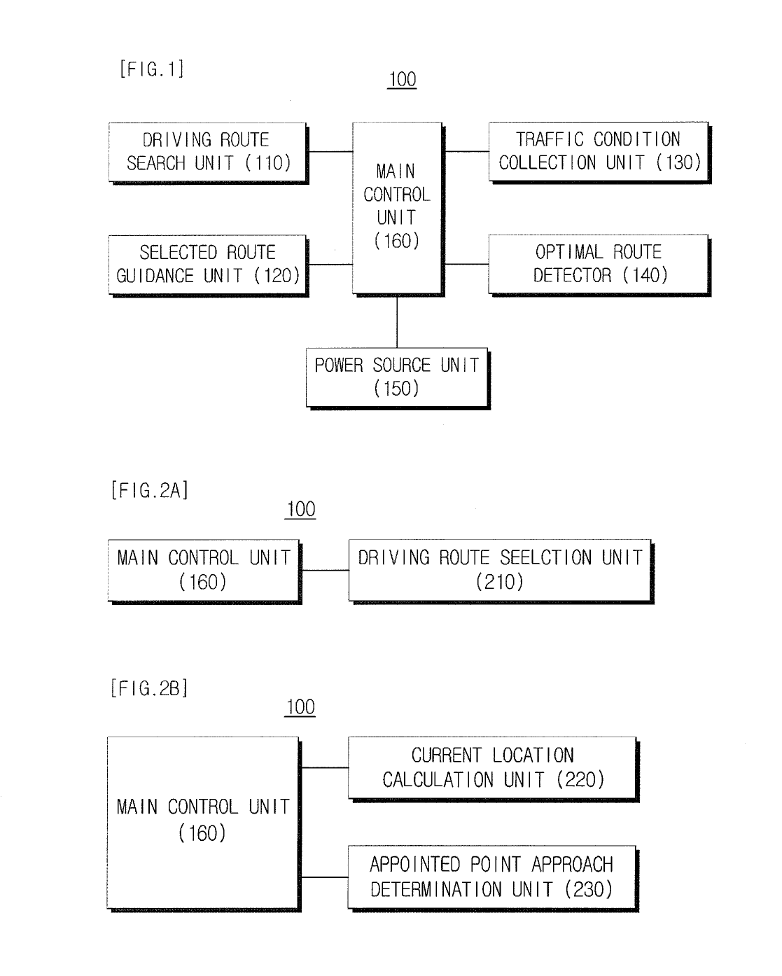

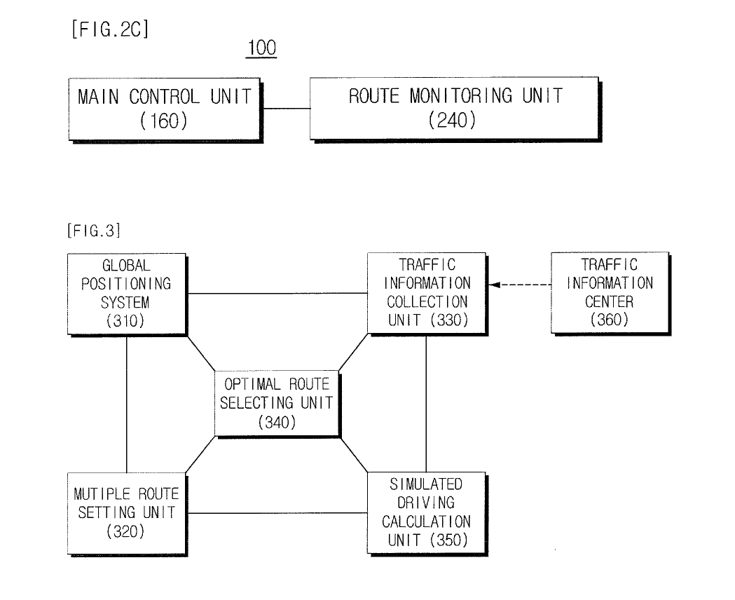

FIG. 1 is a block diagram schematically showing an apparatus for guiding a driving route according to an exemplary embodiment of the present invention. FIGS. 2A, 2B and 2C is a block diagram schematically showing a configuration added to the apparatus for guiding a driving route shown in FIG. 1. The following description will be made with reference to FIGS. 1, 2A, 2B and 2C.

Referring to FIG. 1, an apparatus 100 for guiding a driving route to a destination includes a driving route search unit 110, a selected route guidance unit 120, a traffic condition collection unit 130, an optimal route detector 140, a power source unit 150, and a main control unit 160.

The driving route search unit 110 functions to search driving routes to a destination point from a current point when the destination point is input. The driving route search unit 110 may search passing routes passing through at least one appointed point as driving routes.

The selected route guidance unit 120 functions to guide a selected route selected among the searched driving routes.

The traffic condition collection unit 130 functions to collect traffic condition information for each section to the destination point from the appointed point when approaching the appointed point while guiding the selected route. The traffic condition collection unit 130 may collect traffic condition information by using a traffic information center or a traffic control surveillance center. The appointed point may be, for example, a junction such as a crossroad.

The optimal route detector 140 functions to detect an optimal route to the destination point from the appointed point on the basis of the traffic condition information. The optimal route detector 140 may detect a passing route passing through at least one appointed point selected from the other appointed points except for the appointed point which has been already approached, as the optimal route. The optimal route detector 140 may detect a driving route to enable driving in the shortest time, as the optimal route.

The traffic condition collection unit 130 and the optimal route detector 140 may be driven whenever approaching the appointed points. That is, in the exemplary embodiment of the present invention, the traffic condition collection unit 130 and the optimal route detector 140 are repeatedly driven whenever approaching the appointed points prior to the arrival at the destination point.

The power source unit 150 functions to supply power to each of the constituent units constituting the apparatus 100 for guiding a driving route.

The main control unit 160 functions to control an overall operation of each of the constituent units constituting the apparatus 100 for guiding a driving route.

The apparatus 100 for guiding a driving route may further include a driving route selection unit 210 as shown in FIG. 2A. The driving route selection unit 210 functions to select any one of a route corresponding to a user's input, a route to enable driving in the shortest time, a route to enable driving the shortest distance, and a route having fewest traffic signal waiting sections, as the selected route. Herein, the traffic signal waiting section refers to a section where there is a traffic light or a crosswalk.

The driving route selection unit 210 may select any one route according to a predetermined order of priority when there are at least two selectable routes. In the exemplary embodiment of the present invention, the route corresponding to the user's input may have a first priority, the route to enable driving in the shortest time may have a second priority, the route to enable driving the shortest distance may have a third priority, and a route having fewest traffic signal waiting sections may have a fourth priority. However, the exemplary embodiment of the present invention is not necessarily limited to the order of priority.

The apparatus 100 for guiding a driving route may further include a current location calculation unit 220 and an appointed point approach determination unit 230 as shown in FIG. 2B. The current location calculation unit 220 functions to calculate a current location in real time. The current location calculation unit 220 may calculate a current location by using a global positioning system (GPS).

The appointed point approach determination unit 230 functions to determine whether to approach the appointed point on the basis of a time required to drive from the current location to the appointed point or a distance from the current location to the appointed point. When whether to approach the appointed point is determined on the basis of the time required to drive from the current location to the appointed point, a reference time may be 30 seconds to 10 minutes, and when whether to approach the appointed point is determined on the basis of the distance from the current location to the appointed point, a reference distance may be 5 m to 5 km. According to the reference, when the time required to reach the appointed point from the current location is calculated as 5 minutes, it is determined that the appointed point is approached, and when the time required to reach from the current location to the appointed point is calculated as 15 minutes, it is determined that the appointed point is not approached. However, the present invention is not necessarily limited to the reference described in the exemplary embodiment.

The apparatus 100 for guiding a driving route may further include a route monitoring unit 240 as shown in FIG. 2C. The route monitoring unit 240 functions to perform simulated driving of the other routes except for the optimal route to monitor the other routes in real time.

The apparatus 100 for guiding a driving route is an apparatus for guiding an optimal route by using multiple routes and traffic information. That is, the apparatus 100 for guiding a driving route is an apparatus for guiding the optimal route to enable arrival at the desired destination in the shortest time by searching the optimal route in consideration of the traffic information and road conditions. The apparatus 100 for guiding a driving route may be mounted in a navigation system for a vehicle or a global positioning system for a vehicle.

The apparatus 100 for guiding a driving route collects traffic information and road conditions to reflect the collected traffic information and road conditions to guide a route. The apparatus 100 for guiding a driving route may generate multiple routes to the destination according to user's settings or may generate multiple routes to the destination based on a junction predetermined by a user. The apparatus 100 for guiding a driving route updates traffic information whenever reaching the junction to select an optimal route among the multiple routes on the basis of the latest traffic information. The apparatus 100 for guiding a driving route may also display a driving result for each route to the user by using the simulated driving of the set multiple routes other than an actual driving route.

The apparatus 100 for guiding a driving route may select an effective route by designating a junction according to a user's input without depending on only a detour when setting the multiple routes. The apparatus 100 for guiding a driving route may easily process and analyze data by collecting only traffic information associated with the multiple routes. The apparatus 100 for guiding a driving route may exactly predict the optimal route on the basis of the latest traffic information and enable arrival at the destination in the shortest time by determining the route at the time of entry to the junction according to the user's input. Further, the apparatus 100 for guiding a driving route may display efficiency of the optimal route to the user by performing the simulated driving of the multiple routes.

FIG. 3 is an exemplary diagram showing an exemplary embodiment of the apparatus for guiding a driving route shown in FIG. 1 and illustrates an inner configuration of the apparatus for guiding an optimal route by using the multiple routes and traffic information. Referring to FIG. 3, the apparatus for guiding a driving route according to the exemplary embodiment includes a global positioning system 310, a multiple route setting unit 320, a traffic information collection unit 330, an optimal route selection unit 340, and a simulated driving calculation unit 350.

The traffic information collection unit 330 collects traffic information from a traffic information center 360. The traffic information collection unit 330 may collect only traffic information on the multiple routes in some cases. As a method of collecting traffic information by the traffic information collection unit 330, various methods such as a mobile phone mobile communication and digital multimedia broadcasting (DMB) may be used. The configuration 330 is a concept corresponding to the traffic condition collection unit 130 in FIG. 1.

The global positioning system 310 receives a navigation signal from a navigation satellite to calculate a user's location. The configuration 310 is a concept corresponding to the current location calculation unit 220 in FIG. 2B.

The multiple route setting unit 320 receives a starting point and a destination to search a route and receives a junction and the route from a user to generate multiple routes.

The optimal route selection unit 340 selects an optimal route again by using the multiple routes and the traffic information when the user approaches the junction and guides the optimal route among the multiple routes to the user. The configuration 340 is a concept corresponding to the optimal route detector 140 in FIG. 1.

The simulated driving calculation unit 350 collects data on the other multiple routes except for the route selected by the user in real time to perform simulated driving of the other multiple routes and presents the result to the user. The configuration 350 is a concept corresponding to the route monitoring unit 240 in FIG. 2C.

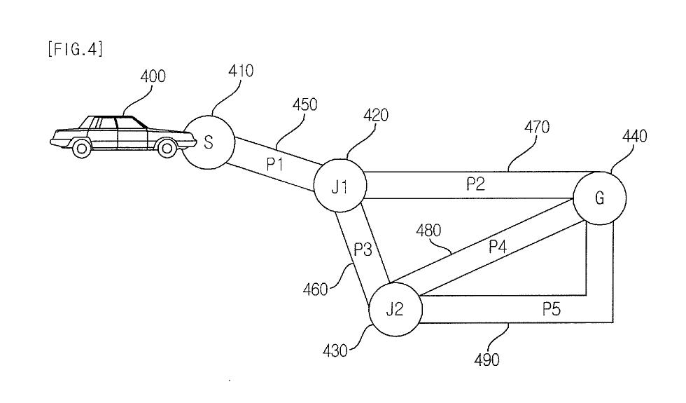

FIG. 4 is an exemplary diagram for describing a method for guiding an optimal route based on multiple routes by using the apparatus shown in FIG. 3. Reference numeral 400 denotes a vehicle in which the user rides and reference numerals S 410 and G 440 denote a starting point and a destination point, respectively. The junction is represented by JI 420 and J2 430 and the driving routes are represented by P1 450, P2 470, P3 460, P4 480, and P5 490.

A general global positioning system for a vehicle searches a route on the basis of the starting point S 410 and the destination G 440 to guide the movement to P1 450 and P2 470 as the optimal route. Meanwhile, when a traffic accident happens or traffic controls are in operation due to road works or the like at point P2 470, more time may be required to reach the destination compared to a case of using a detour. The present invention is contrived to solve the above-described problem and sets J1 420 and J2 430 as junctions and includes additional routes such as P3 460, P4 480, and P5 490. The present invention guides the optimal route based on the multiple routes in consideration of traffic conditions according to the configuration. Meanwhile, the addition of junctions and resultant addition of driving routes may be determined according to the user's input and the apparatus may also add junctions and resultant driving routes for itself according to a basis (for example, setting a crossroad as a junction).

When route guidance starts, the vehicle 400 in which the user rides moves from point S 410 to point J1 420 along route P1 450. When the vehicle 400 approaches point J1 420, the latest traffic information is collected and an optimal route from point J1 420 to point G 440 is searched again on the basis of the information. When route P2 470 is used, it is possible to reach point G 440 in the shortest time, but when a traffic accident happened or traffic controls are in operation at point P2 470, route P3 460 and route P4 480 are guided as the optimal route. When the vehicle 400 approaches point J2 430 along route P3 460, the latest traffic information is collected again, and an optimal route from point J2 430 to point G 440 is searched again based on the information. When a traffic accident happened or traffic controls are in operation at point P4 480 during movement along route P3 460, the optimal route is changed to route P5 490. Meanwhile, simulated driving of non-selected routes among the multiple routes is performed based on real-time traffic information. This is to allow the user to select a driving route to enable the arrival at the destination in the shortest time by comparing a selected route and a non-selected route in real time.

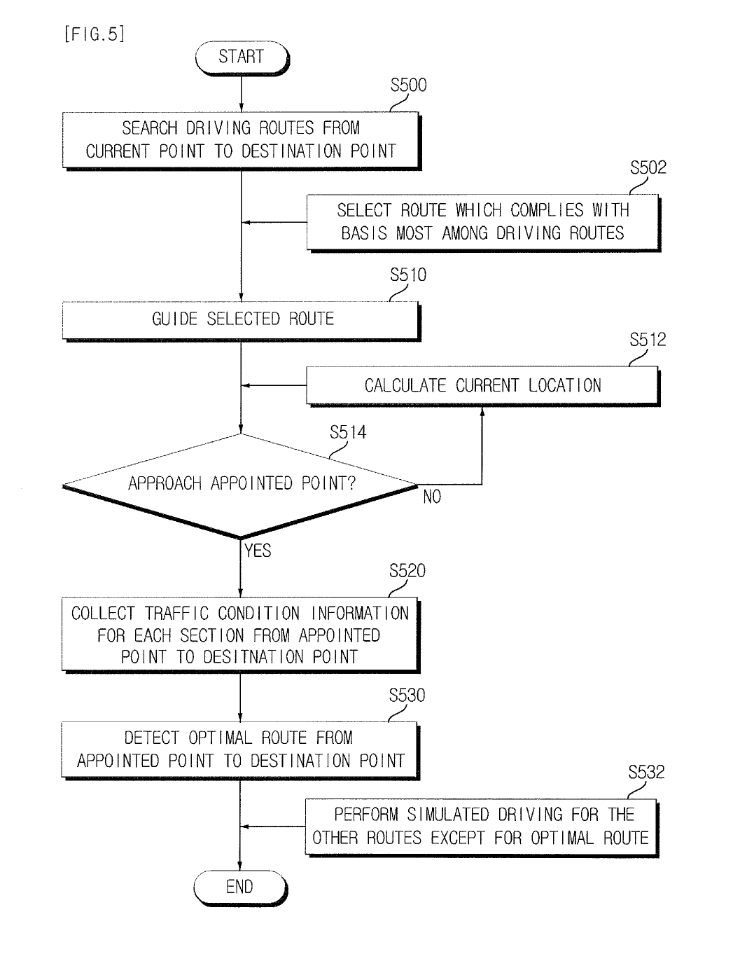

FIG. 5 is a flowchart schematically showing a method for guiding a driving route to a destination according to an exemplary embodiment of the present invention. The following description will be made with reference to FIGS. 1, 2, and 5.

First, when a destination point is input, the driving route search unit 110 searches driving routes from a current point to a destination point (driving route searching step, S500). In the driving route searching step S500, passing routes passing through at least one appointed point as driving routes may be searched.

After the driving route searching step S500, the selected route guidance unit 120 guides a selected route selected from the driving routes (selected route guiding step, S510).

After the selected route guiding step S510, the traffic information collection unit 130 collects traffic condition information for each section from the appointed point to the destination point when approaching the appointed point while executing the selected route guidance (traffic condition collecting step, S520).

After the traffic condition collecting step S520, the optimal route detector 140 detects an optimal route from the appointed point to the destination point based on the traffic condition information (optimal route detecting step, S530). In the optimal route detecting step S530, a passing route passing through at least one appointed point selected from the other appointed points except for the approached appointed point may be detected as the optimal route. In the optimal route detecting step S530, a driving route to enable driving in the shortest time may be detected as the optimal route.

The traffic condition collecting step S520 and the optimal route detecting step S530 are repeatedly performed whenever approaching the appointed point prior to the arrival at the destination point.

A driving route selecting step S502 may be performed between the driving route searching step S500 and the selected route guiding step S510. In the driving route selecting step S502 which is performed by the driving route selection unit 210, any one of a route corresponding to a user's input, a route to enable driving in the shortest time, a route to enable driving the shortest distance, and a route having fewest traffic signal waiting sections is selected as the selected route. In the driving route selecting step S502, when there are at least two selectable routes, any one route may be selected according to a predetermined order of priority.

A current location calculating step S512 and an appointed point approach determining step S514 may be performed between the selected route guiding step S510 and the traffic condition collecting step S520. In the current location calculating step S512 which is performed by the current location calculation unit 220, a current location is calculated in real time. In the appointed point approach determining step S514 which is performed by the appointed point approach determination unit 230, whether to approach the appointed point is determined based on a time required to drive from the current location to the appointed point or a distance from the current location to the appointed point.

After the optimal route detecting step S530, a route monitoring step S532 may be performed. In the route monitoring step S532 which is performed by the route monitoring unit 240, simulated driving of the other routes except for the optimal route is performed to monitor the other routes in real time.

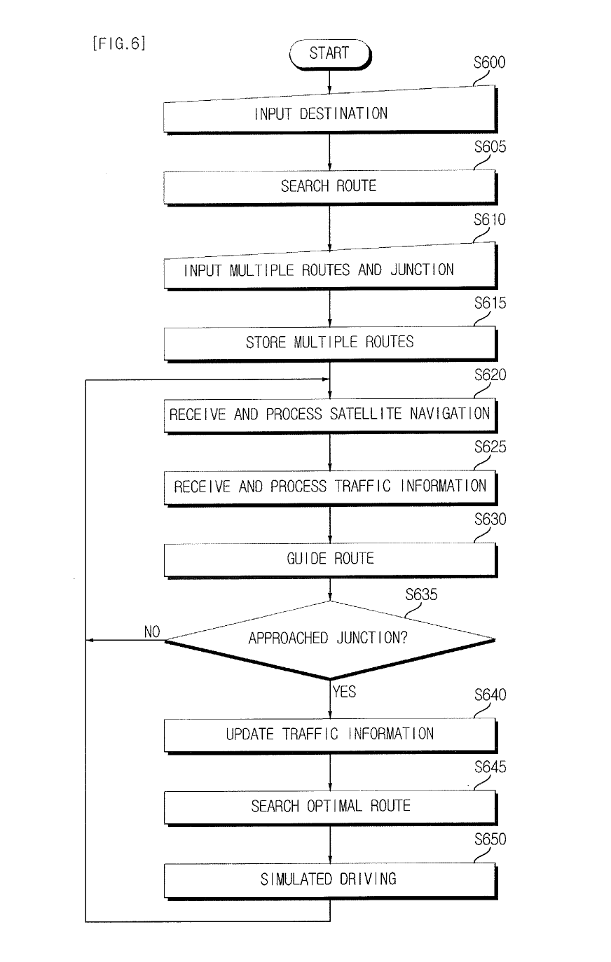

FIG. 6 is a flowchart of an exemplary embodiment of a method for guiding an optimal route by using the apparatus shown in FIG. 3, that is, a global positioning system for a vehicle using multiple routes and traffic information. The following description will be made with reference to FIG. 6.

The method for guiding an optimal route of FIG. 6 has a characteristic that a route may be changed in real time. The method for guiding an optimal route of FIG. 6 includes a destination inputting step S600, a route searching step S605, a multiple route and junction inputting step S610, a multiple route storing step S615, a satellite navigation receiving and processing step S620, a traffic information receiving and processing step S625, a route guiding step S630, a junction approach determining step S635, a traffic information updating step S640, an optimal route searching step S645, and a simulated driving step S650.

A user inputs a destination for route guidance (S600) and a global positioning system searches a route to the destination (S605). The user inputs junctions and multiple routes so as to set multiple routes (S610). In this case, one or more junctions and multiple routes may be selected and a route preferred by the user may be input. The global positioning system stores the multiple routes (S615) and receives and processes a navigation signal and traffic information (S620 and S625) to start to guide a route (S630). Whether to approach a junction pre-set by the user is determined (S635). When not approaching the junction, route guidance is continued by the corresponding route and when approaching the junction, traffic information is updated (S640) and an optimal route is searched among the multiple routes (S645). The searched result is notified to a user and simulated driving of the other routes is performed (S650) to make comparison with the driving route possible.

The method for guiding an optimal route of FIG. 6 may designate a route preferred by the user by setting the multiple routes. Further, accuracy of the optimal route among the multiple routes may be improved using real-time traffic information and the user can check the optimal route in real time by introducing a simulated driving method. The method for guiding an optimal route in FIG. 6 may be implemented as vehicle navigation software to be provided in a global positioning system for a vehicle.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for guiding a driving route to a destination, comprising:
a driving route search unit searching driving routes from a current point to a destination point when the destination point is input;
a selected route guidance unit guiding a selected route selected from the driving routes;
a traffic condition collection unit collecting traffic condition information for each section from an appointed point to the destination point when approaching the appointed point while executing the guidance; and
an optimal route detector detecting an optimal route from the appointed point to the destination point based on the traffic condition information.

2. The apparatus of claim 1, wherein the optimal route detector detects a driving route to enable driving in the shortest time as the optimal route.

3. The apparatus of claim 1, wherein whenever approaching the appointed point prior to the arrival at the destination point, the traffic condition collection unit and the optimal route detector are repeatedly driven.

4. The apparatus of claim 1, wherein the driving route search unit searches passing routes passing through at least one appointed point as the driving routes or the optimal route detector detects passing routes passing through at least one appointed point selected from the other appointed points except for an approached appointed point, as the optimal route.

5. The apparatus of claim 1, further comprising:
a driving route selection unit selecting any one of a route corresponding to a user's input, a route to enable driving in the shortest time, a route to enable driving the shortest distance, and a route having fewest traffic signal waiting sections, as the selected route.

6. The apparatus of claim 5, wherein the driving route selection unit selects any one route according to a predetermined order of priority when there are at least two selectable routes.

7. The apparatus of claim 1, further comprising:
a current location calculation unit calculating a current location in real time; and
an appointed point approach determination unit determining whether to approach the appointed point based on a time required to drive from the current location to the appointed point or a distance from the current location to the appointed point.

8. The apparatus of claim 1, further comprising:
a route monitoring unit performing simulated driving of the other routes except for the optimal route to monitor the other routes in real time.

9. A method for guiding a driving route to a destination, comprising:
searching driving routes from a current point to a destination point when the destination point is input;
guiding a selected route selected from the driving routes;
collecting traffic condition information for each section from an appointed point to the destination point when approaching the appointed point while executing the guidance; and
detecting an optimal route from the appointed point to the destination point based on the traffic condition information.

10. The method of claim 9, wherein the detecting of the optimal route detects a driving route to enable driving in the shortest time as the optimal route.

11. The method of claim 9, wherein whenever approaching the appointed point prior to the arrival at the destination point, the collecting of the traffic condition information and the detecting of the optimal route are repeatedly performed.

12. The method of claim 9, wherein the searching of the driving routes searches passing routes passing through at least one appointed point as the driving routes or the detecting of the optimal route detects passing routes passing through at least one appointed point selected from the other appointed points except for an approached appointed point approaching, as the optimal route.

13. The method of claim 9, further comprising:
selecting any one of a route corresponding to a user's input, a route to enable driving in the shortest time, a route to enable driving the shortest distance, and a route having fewest traffic signal waiting sections, as the selected route.

14. The method of claim 9, further comprising:
performing simulated driving of the other routes except for the optimal route to monitor the other routes in real time.
